(19) United States
(12) Patent Application Publication
(10) Pub. No.: US 2018/0116224 A1
(43) Pub. Date: May 3, 2018

(54) PESTICIDAL COMPOSITIONS AND RELATED METHODS

(71) Applicant: Dow AgroSciences LLC, Indianapolis, IN (US)

(72) Inventors: Miriam BURKHART, Indianapolis, IN (US); Luis E. GOMEZ, Carmel, IN (US); Lei LIU, Carmel, IN (US); Christopher WAID, Indianapolis, IN (US); Dan WU, Carmel, IN (US); Mary RUSHTON, Indianapolis Thorntown, IN (US)

(21) Appl. No.: 15/561,896

(22) PCT Filed: Mar. 30, 2016
(86) PCT No.: PCT/US2016/025097

§ 371 Date: Sep. 26, 2017

Related U.S. Application Data
(60) Provisional application No. 62/141,140, filed on Mar. 31, 2015.

(51) Int. Cl. A01N 47/40; C05F 11/00; C05G 3/06; C05D 3/00; C05G 3/04; C09K 17/02; C05G 3/02

(52) U.S. Cl. CPC A01N 47/40; C05F 11/00; C05G 3/06; C05G 3/02; C05G 3/04; C09K 17/02; C05D 3/00

(57) ABSTRACT

A pesticidal composition comprises at least one soil conditioner selected from the group consisting of organic soil conditioners, microorganisms, activators, and combinations thereof and an active ingredient group alpha (AIGA) compound. The weight ratio of soil conditioner to AIGA compound is at least about 20:1. The pesticidal composition shows an enhanced residue activity of the AIGA compound in soil. A method of controlling a sap-feeding insect on a top part of the plant comprises applying a pesticidally effective amount of such pesticidal composition to soil around a root system of the plant. A method of controlling pests comprises applying a pesticidally effective amount of such pesticidal composition to at least one of: soil, seed of a plant, a portion of a plant, and locus where control of pests is desired.

### PRIORITY CLAIM

This application is a national phase entry under 35 U.S.C. § 371 of international Patent Application PCT/US2016/025097 filed on Mar. 30, 2016, which claims the benefit of the filing date of U.S. Provisional Patent Application Ser. No. 62/141,140, filed Mar. 31, 2015, which is incorporated herein in its entirety.

### TECHNICAL FIELD OF THE DISCLOSURE

Various embodiments relate generally to pesticidal compositions and to methods of using such pesticidal compositions in controlling pests.

### BACKGROUND

Controlling pest population is essential to modern agriculture, food storage, and hygiene. Currently, safer and effective encapsulated pesticide formulations play a significant role in controlling pest populations. Unfortunately, most pesticide formulations, especially liquid based formulations, lose their efficacy relatively soon after application. Such pesticide formulations must, therefore, be reapplied to ensure pest control. Additionally, formulations with a short period of post application activity may result in periods of time during which an area is vulnerable to infestation by pests.

### BRIEF DESCRIPTION OF THE FIGURES

FIG. 1 is a graph showing % sulfoxaflor recovery in the inoculated soil from Fresno, Calif. after three days for a pesticidal composition comprising sulfoxaflor and ACCELL® STR soil conditioner, in comparison to that for a control composition comprising sulfoxaflor but not soil conditioner.

FIG. 2 is a graph showing % sulfoxaflor recovery in the inoculated Midwest soil after three days for a pesticidal composition comprising sulfoxaflor and ACCELL® STR soil conditioner, in comparison to that for a control composition comprising sulfoxaflor but not soil conditioner.

FIG. 3 is a graph showing % sulfoxaflor recovery in the inoculated Midwest soil after three days for two pesticidal compositions that contained sulfoxaflor and two different mineral soil conditioners (gypsum and perlite), in comparison to that for a control pesticidal composition comprising sulfoxaflor but not soil conditioner.

FIG. 4 is a graph showing numbers of live green peach aphids (Myzus persicae) at 21 days after the soil treatment using different compositions.

FIG. 5 is a graph showing numbers of live green peach aphids (Myzus persicae) at 28 days after the soil treatment using different compositions.

### DETAILED DESCRIPTION

As used herein, the term “pest” means and includes invertebrates, organisms and microorganisms (including pathogens) that negatively affect plants or animals. This includes organisms that spread disease and/or damage the host and/or compete for host nutrients. In addition, plant pests are organisms known to associate with plants and which, as a result of that association, cause a detrimental effect on the health and vigor of plant. Plant pests include but are not limited to fungi, bacteria, insects, arachnids, nematodes, slugs, snails, etc.

The term “pesticide,” as used herein, means and includes any substance that may be used to control agricultural, natural, environmental, and domestic/household pests, such as insects, fungi, bacteria, and viruses.

The terms “control” and “controlling,” as used herein, mean and include killing, eradication, arresting in growth, inhibition, reducing in number and/or imparting sterility.

The term “insecticide,” as used herein, refers to a specific category of pesticides used for controlling insects.

The term “active ingredient,” as used herein, means and includes a material having activity useful in controlling pests, and/or that is useful in helping other materials have better activity in controlling pests, examples of such materials include, but are not limited to, acaricides, algicides, avicides, bactericides, fungicides, herbicides, insecticides, molluscicides, nematicides, rodenticides, virucides, antifeedants, bird repellents, chemosterilants, herbicide safeners, insect attractants, insect repellents, mammal repellents, mating disrupters, plant activators, plant growth regulators, and synergists. Specific examples of such materials may include, but are not limited to, the materials listed in the active ingredient group alpha. Active ingredient group alpha compound has a short soil half-life, and therefore, its soil stability may be improved using the technology described herein.

The term “active ingredient group alpha” (hereafter “AIGA”), as used herein, means and includes collectively the following materials:

(1) Insecticides—acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor (preferred), thiacloprid, thiamethoxam, thiocyclam hydrogen oxalate, thiometon, thiometon sulfone, triazamate, and vamidothion;

(2) Fungicides—carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, and triadimefon.

The term “initial soil,” as used herein, means soil in its original state without adding anything to it.

The term “initial soil moisture,” as used herein, means an amount of water in the soil, as described by a weight percent.

The term “dry soil mass,” as used herein, means a total mass of the dry soil particles without any moisture (as if all of the moisture had evaporated out of it). The dry soil mass may be determined using the following equation:

Dry Soil Mass=Initial Soil Mass−(Initial Soil Mass×Moisture Content %)

The term “final soil mixture,” as used herein, means the soil mass after addition of the pesticidal formulation, which may include sulfoxaflor solution, surfactant/adjuvant solution, and/or additional water, to the initial soil.

The term “total soil liquid,” as used herein, means a total amount of liquid in soil including the initial soil moisture and the added pesticidal formulation, which may include sulfoxaflor solution, surfactant/adjuvant solution, and/or additional water. The total soil liquid may be determined using the following equation:

Total Soil Liquid=(Initial Soil Mass×Moisture Content %)+Mass of Pesticidal Formulation

The term “ppm,” as used herein, stands for part-per-million, and refers to the amount of a component of interest in micrograms (μg) per one gram of soil sample.

The term “sulfoxaflor concentrate,” as used herein, refers to a sulfoxaflor concentrate at a sulfoxaflor concentration of 240 grams per liter (g/L) (such as the CLOSER® SC insecticide available from Dow AgroSciences) or a sulfoxaflor concentrate at a sulfoxaflor concentration of 500 grams per kilogram (g/kg) (such as the TRANSFORM® WG insecticide also available from Dow AgroSciences). The sulfoxaflor concentrate may be in the form of an aqueous suspension concentrate formulation (SC), a water dispersible granule formulation (WDG), an oil dispersion formulation (OD), or a suspension emulsion formulation (SE).

As used herein, the term “sulfoxaflor” is the provisionally approved name for [methyl(oxo){1-[6-(trifluoromethyl)-3-pyridyl]ethyl}-λ⁶-sulfanylidene]cyanamide (IUPAC designation) which is also known as N-[methyloxido[1-[6-(trifluoromethyl)-3-pyridinyl]ethyl]-λ⁶-sulfanylidene]cyanamide (CAS Name, CAS registry number 946578-00-3). Sulfoxaflor is a mixture of four possible stereoisomers, the chemical structures of which are as follows:

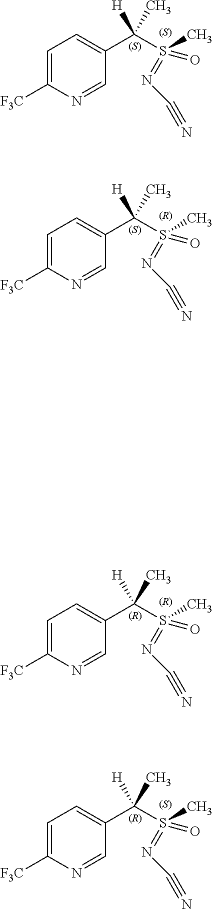

Sulfoxaflor demonstrates efficacy against a broad spectrum of pests. Sulfoxaflor has demonstrated excellent acute efficacy against a broad spectrum of sap-feeding insects like aphids. Sulfoxaflor has also been shown to have a high level of efficacy against hard to control true bugs, such as Lygus. Additionally, sulfoxaflor possesses high levels of intrinsic activity and controls insect populations resistant to neonicotinoid and other insecticide modes of action including the organophosphates, pyrethroids, and carbamates. For example, foliar application of sulfoxaflor has demonstrated efficacy under field conditions that is equal or superior to neonicotinoid compounds at equivalent or lower use rates, particularly for aphid control.gDNA genomic deoxyribonucleic acid

However, the residual activity of sulfoxaflor in soil applications is relatively less than desirable because sulfoxaflor degrades very rapidly in soil. The degradation of pesticides in soil may be defined by half-life DT50 value. Half-life DT50 is an amount of time taken for 50% of the pesticide to disappear from soil by degradation. The degradation processes may be biological processes (biodegradation) or physicochemical processes (hydrolysis, photolysis, etc.). The pesticide having half-life DT50 value of less than 20 days is readily degradable in soil.

The average half-life DT50 of sulfoxaflor in laboratory soil metabolism studies, conducted in the dark, was less than one day. Degradation was also rapid under field conditions, with an average half-life DT50 of four days in field dissipation studies. Improving stability of sulfoxaflor in soil would extend the sulfoxaflor soil half-life making it available for plant uptake to control sap-feeding insects on the top part of the plant for longer periods of time. Therefore, the sulfoxaflor pesticidal composition with improved soil stability is desirable in order to increase the lifetime of sulfoxaflor in soil and to slow the rate of loss due to degradation.

In one particular embodiment, the pesticidal composition comprises at least one soil conditioner selected from microorganisms, organic soil conditioners, activators, or combinations thereof and an active ingredient group alpha (AIGA) compound. The weight ratio of soil conditioner to AIGA compound is at least about 20:1, and particularly at least about 25:1.

The AIGA compound may include collectively the following materials: (1) an insecticide comprising acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor (preferred), thiacloprid, thiamethoxam, thiocyclam hydrogen oxalate, thiometon, thiometon sulfone, triazamate, vamidothion, or mixtures thereof; (2) a fungicide comprising carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, triadimefon, or mixtures thereof; or a mixture of (1) and (2).

The term “soil conditioner,” as used herein, means and includes a material added to the soil, with the primary function of improving horticultural or agronomic conditions of soil. Soil conditioners vary greatly in both their origins and compositions. Soil conditioners may be synthetic or naturally occurring. Furthermore, soil conditioners may vary in an application rate, and expected or claimed mode of action. Soil conditioners have been used to provide various benefits such as improved soil structure and aeration; increased water-holding capacity; increased availability of water to plants; reduced compaction and hardpan conditions; improved tile drainage effectiveness, alkali soil reclamation and/or release of “locked” nutrients; enhanced chemical incorporation; increased root development; higher yields and quality and so on. See Hickman, J. S. and D. A. Whitney, Soil conditioners, North Central Regional Extension Publication No. 295, 1984. Soil conditioners may be organic soil conditioners, inorganic soil conditioners, microorganisms, or activators. Examples of inorganic soil conditioners may include, but are not limited to, mineral conditioners, such as gypsum (CaSO4.H2O), limestone (CaCO3), perlite (i.e., an amorphous volcanic glass), crushed rock, and other mineral products having high calcium and/or magnesium contents.

Suitable soil conditioners may include, but are not limited to, microorganisms, organic soil conditioners, activators, or combinations thereof.

Non-limiting examples of microorganisms for soil conditioner may include, but are not limited to, Bacillus subtilis strain BS5 that is capable of producing surfactin; bacterial strains Stenotrophomonas maltophilia, Stenotrophomonas sp.; microbial inoculant such as EM-1® bacterial-fungi preparate (aka “Effective Microorganisms”) from EM Research Organization, Inc. (Japan), which consists of a suspension of at least 80 naturally occurring bacteria, lactic acid bacteria, yeasts, cellulolytic bacteria, and actinomycetes; BIOSTART™ RhizoBoost product available from Bio-Cat Microbials, LLC (Shakopee, Minn.), which is a water suspension of Bacillus laterosporus (strains CM-3 and CM-33), Bacillus chitinosporus (strain CM-1), and Bacillus licheniformis (strain HB-2); or BIOSTART™ Defensor product available from Bio-Cat Microbials, LLC (Shakopee, Minn.), which is a water suspension of Bacillus subtilis (CM-5 strain) and Bacillus cereus (BCE-2 strain).

Non-limiting examples of organic soil conditioners may include, but are not limited to, soil organic matters; humates; animal manures; green manure crops; crop residues such as leaf mulch; sawdust; waste organic matters such as sewage sludge, sludge compost, composted garbage, food waste, municipal solid waste, and agro-industrial wastes; biochar (a pyrolysis product of biomass); soya lecithin; or yeast protein.

Soil organic matter is defined as the organic fraction of soil that includes plant and animal residues at various stages of decomposition, cells and tissues of organisms, and compounds synthesized by the soil organism population. Soil organic matter comprises a wide array of compounds ranging from fats, carbohydrates, and proteins to high molecular weight humic and fulvic acids.

Humate is a commercial product derived from oxidized lignite and an earthy coal-like substance associated with lignite outcrops. Commercial humate comprises from about 30% to about 60% weight of humic acids. Commercial humate contains very little fulvic acid and biologically important materials such as proteins and polysaccharides.

Manure is largely composed of partially decomposed plant material plus a wide variety of organisms. Many of the organic compounds in animal manure are similar to those found in soil organic matter.

Yeast protein may be used as an organic soil conditioner in the pesticidal composition. For example, the organic soil conditioner may comprise a yeast protein-surfactant complex, such as ACCELL®-STR soil conditioner product from Advanced BioCatalytics Corporation (Irvine, Calif.), which contains about 50% by volume of heat-shocked yeast Saccharomyces cerevisiae proteins ferment, about 25.00% by volume of sodium dioctylsulfosuccinate (DOSS, 75% solution), about 15% by volume of propylene glycol, and about 10% by volume of hexylene glycol.

In a particular embodiment, the pesticidal composition comprises at least one soil conditioner and an active ingredient group alpha (AIGA) compound, wherein the weight ratio of soil conditioner to AIGA compound is at least about 20:1, and wherein the soil conditioner comprises a yeast protein-surfactant complex. The yeast protein-surfactant complex may comprise about 50% by volume of heat-shocked yeast Saccharomyces cerevisiae proteins ferment, about 25.00% by volume of sodium dioctylsulfosuccinate (DOSS, 75% solution), about 15% by volume of propylene glycol, and about 10% by volume of hexylene glycol. The ACCELL®-STR soil conditioner from Advanced BioCatalytics Corporation may be used as the yeast protein-surfactant complex.

The pesticidal composition includes a unique combination of soil conditioner and AIGA compound at a selected weight ratio. The pesticidal composition increases the soil half-life of AIGA compound, while maintaining (if not enhancing) the pesticidal activities of AIGA compound.

In some embodiments, the pesticidal composition comprises at least one soil conditioner and an AIGA compound, wherein the weight ratio of soil conditioner to AIGA compound is between about 100:1 and about 20:1, more particularly between about 100:1 and about 30:1, and still more particularly between about 100:1 and about 40:1.

In some embodiments, the pesticidal composition comprises at least one soil conditioner and an AIGA compound, wherein the weight ratio of soil conditioner to AIGA compound is between about 65:1 and about 20:1, more particularly between about 65:1 and about 25:1, and still more particularly between about 65:1 and about 30:1.

In some embodiments, the pesticidal composition comprises at least one soil conditioner and an AIGA compound, wherein the weight ratio of soil conditioner to AIGA compound is between about 50:1 and about 20:1, more particularly between about 50:1 and about 25:1, and still more particularly between about 50:1 and about 30:1.

In some further embodiments, the pesticidal composition comprises at least one soil conditioner and an AIGA compound, wherein the weight ratio of soil conditioner to AIGA compound is between about 40:1 and about 20:1, and more particularly between about 40:1 and about 30:1.

Contact (with an organism): As used herein, the term “contact with” or “uptake by” an organism (e.g., a coleopteran), with regard to a nucleic acid molecule, includes internalization of the nucleic acid molecule into the organism, for example and without limitation: ingestion of the molecule by the organism (e.g., by feeding); contacting the organism with a composition comprising the nucleic acid molecule; and soaking of organisms with a solution comprising the nucleic acid molecule.

In yet further embodiments, the pesticidal composition comprises at least one soil conditioner and an AIGA compound, wherein the weight ratio of soil conditioner to AIGA compound is between about 30:1 and about 20:1, and more particularly between about 30:1 and about 25:1.

In one particular embodiment, the AIGA compound in the pesticidal composition comprises sulfoxaflor. Thus, the pesticidal composition may comprise at least one soil conditioner selected from microorganisms, organic soil conditioners, activators, or combinations thereof and sulfoxaflor. The weight ratio of soil conditioner to sulfoxaflor is at least about 20:1, and particularly at least about 25:1. In some embodiments, the weight ratio of soil conditioner to sulfoxaflor is between about 100:1 and about 20:1, more particularly between about 100:1 and about 30:1, and still more particularly between about 100:1 and about 40:1.

In one further particular embodiment, the pesticidal composition comprises at least one soil conditioner and sulfoxaflor, wherein the weight ratio of soil conditioner to sulfoxaflor is at least about 20:1, and wherein the soil conditioner comprises a yeast protein-surfactant complex. The yeast protein-surfactant complex may comprise about 50% by volume of heat-shocked yeast Saccharomyces cerevisiae proteins ferment, about 25.00% by volume of sodium dioctylsulfosuccinate (DOSS, 75% solution), about 15% by volume of propylene glycol, and about 10% by volume of hexylene glycol.

The pesticidal composition may include a solvent. Non-limiting examples of suitable solvents may include, but are not limited toed to, acetone and other ketones, alcohols, esters, aromatic hydrocarbons, aliphatic hydrocarbons, ethers, water, or mixtures thereof.

The pesticidal composition may further include at least one inert ingredient. The optional inert ingredient may be any material commonly used in the art of pesticidal formulation as described, inter alia, in “McCutcheon's Detergents and Emulsifiers Annual,” MC Publishing Corp., Ridgewood, N.J., 1998 and in the “Encyclopedia of Surfactants,” Vol. I-III, Chemical Publishing Co., New York, 1980-81.

In some embodiments, the pesticidal composition may further include at least one additive that allows the pesticidal composition to be at the required concentration and in an appropriate form, permits ease of application and handling, offers ease and stability during transportation and storage, and/or provides enhanced pesticide activity. By way of non-limiting examples, the additive may include, but are not limited to, an antifoaming agent, antioxidant, a dispersant, a thickener, a preservative, a pH buffer, an antifreezing agent, or a diluent.

Any known antifoaming agents may be used. Non-limiting examples of antifoaming agents may be polydialkylsiloxane (e.g., poly dimethylsiloxane), hydrocarbon oil, tetramethydecynediol, or dimethyloctynediol.

Non-limiting examples of antioxidants may include, but are not limited to, alkyl phenol (e.g., butylated hydroxytoluene and anisole), alkyl gallate, ascorbic acid, or tocopherol.

By way of examples and not limitation, the dispersants may include, but are not limited to, a blend of an alkyl naphthalene sulfonate condensate and lignosulfonate, such as MORWET® D-360 powder from Akzo Nobel N.V.

Any known thickeners may be used. Non-limiting examples of thickeners may include, but are not limited to, a microcrystalline cellulose gel such as AVICEL® CL 611 thickener from FMC Corporation (Philadelphia, Pa.), or an organic gum such as KELZAN® S xanthan gum from CP Kelco U.S., Inc. (Atlanta, Ga.), or both.

The pesticidal composition may optionally include at least one preservative. By way of non-limiting example, the preservative may be an aqueous solution of 1,2-benzisothiazolin-3-one, such as PROXEL® GXL preservative from Arch UK Biocides Limited (England).

Oligonucleotide: An oligonucleotide is a short nucleic acid polymer. Oligonucleotides may be formed by cleavage of longer nucleic acid segments, or by polymerizing individual nucleotide precursors. Automated synthesizers allow the synthesis of oligonucleotides up to several hundred bases in length. Because oligonucleotides may bind to a complementary nucleic acid, they may be used as probes for detecting DNA or RNA. Oligonucleotides composed of DNA (oligodeoxyribonucleotides) may be used in PCR, a technique for the amplification of DNAs. In PCR, the oligonucleotide is typically referred to as a “primer,” which allows a DNA polymerase to extend the oligonucleotide and replicate the complementary strand.

Non-limiting examples of pH buffer may include, but are not limited to, an aqueous solution of a weak acid and its conjugate base, or a weak base and its conjugate acid such as, for example, citric acid, ascorbic acid, potassium phosphate or sodium phosphate. The buffer solution may be formulated to maintain a desired pH of about 2 to about 6, particularly a pH of about 2 to about 4 of the pesticidal composition.

Suitable antifreezing agents may include, but are not limited to, propylene glycol, ethylene glycol and glycerol, or mixtures thereof.

In some embodiments, the pesticidal composition may further include an adjuvant surfactant to enhance deposition, wetting and/or penetration of the pesticidal composition onto the target soil, crop, or organism. These optional adjuvant surfactants may be employed as one component of the pesticidal composition during the preparation of pesticidal composition. Alternatively, these optional adjuvant surfactants may be mixed (e.g., tank mixed) with the pesticidal composition after the pesticidal composition is prepared. The amount of adjuvant surfactant may vary from about 0.01% to about 1% by volume, based on a spray-volume of water, preferably from about 0.05% to about 0.5% volume. Suitable adjuvant surfactants may include, but are not limited to, ethoxylated nonyl phenols, ethoxylated synthetic or natural alcohols, salts of the esters or sulfosuccinic acids, ethoxylated organosilicones, ethoxylated fatty amines, or blends of surfactants with mineral or vegetable oils.

The pesticidal composition may be prepared by mixing at least one soil conditioner and an AIGA compound at a predetermined weight ratio of soil conditioner to AIGA compound, in at least one solvent to form a base formulation. Then, other ingredients may be mixed with the base formulation to form the pesticidal composition. Alternatively, the pesticidal composition may be prepared by mixing at least one soil conditioner, an AIGA compound, and other ingredients in at least one solvent.

In one particular embodiment, the pesticidal composition is prepared by first producing a sulfoxaflor concentrate having a sulfoxaflor concentration of 240 grams per liter (g/L) or 500 g/kg, and then mixing (e.g., tank mixing) at least one soil conditioner with the sulfoxaflor concentrate.

Accordingly, in some embodiments, a method of preparing the pesticidal composition comprises mixing at least one soil conditioner with a sulfoxaflor concentrate, wherein the sulfoxaflor concentrate has a sulfoxaflor concentration of 240 g/L or a 500 g/kg.

The present disclosure also envisages to a method of controlling pests. The method comprises applying a pesticidally effective amount of the pesticidal composition to at least one of: soil, seed of a plant, a portion of a plant, and locus where control of pests is desired.

The present disclosure also envisages a method of controlling sap-feeding insects on the top part of plants by applying to the pesticidal composition to the soil around the root system of the plant. The pesticidal composition may be applied to soil using any suitable methods that ensure the penetration of the pesticidal composition into soil. Non-limiting examples of such applications may include, but are not limited to, nursery tray application, furrow application, soil drenching, soil injection, drip irrigation, or application through sprinklers or central pivot.

Furthermore, the present disclosure envisages a method of controlling pests that comprises applying the pesticidal composition to soil. Upon applying the pesticidal composition to soil, the plant roots may absorb the pesticidal composition from soil and take it up into the foliar portions of the plant to control root and stem feeding pests such as, without limitation, above ground chewing pests and sap-feeding pests.

Furthermore, the present disclosure envisages a method of controlling pests that comprises applying the pesticidal composition to a portion of the plant. By way of non-limiting examples, control of foliar-feeding insects may be achieved by drip irrigation or furrow application, by treating the soil with for example pre- or post-planting soil drench, or by treating the seeds of a plant before planting with the pesticidal composition.

The pesticidal composition may be formulated into various forms for appropriate uses. By way of non-limiting examples, the pesticidal composition may be formulated as a concentrated emulsion, an emulsifiable concentrate, a suspension concentrate, a water soluble liquid, an ultralow volume solution, a water dispersible granule, a granule, a gel, a dry flowable and wettable powder, a dust, a tablet, a microencapsulation, a seed treatment, a bait, or a fumigant.

The pesticidal composition may be applied as a liquid formulation. By way of non-limiting examples, the liquid formulation may include, but is not limited to, water-soluble formulation, water-emulsifiable formulation, water-dispersible formulation, oil-soluble formulation, or oil-dispersible formulation.

The disclosed pesticidal composition may be applied as an aqueous suspension or emulsion prepared from a concentrated formulation of the pesticidal composition. Such water-soluble, water-dispersible, or water-emulsifiable formulation may be either solid (usually known as a wettable powder or a water dispersible granule) or liquid (usually known as an emulsifiable concentrate or an aqueous suspension).

The pesticidal composition may be applied as a wettable powder. A wettable powder, which may be compacted to form a water dispersible granule, may comprise an intimate mixture of the pesticidal composition, a carrier and, optionally, additional surfactants for facilitating the dispersion in water. Non-limiting examples of the carriers may include, but are not limited to, attapulgite clays, montmorillonite clays, diatomaceous earths, or purified silicates. By way of non-limiting examples, the optional surfactants for facilitating the dispersion in water may include, but are not limited to, sulfonated lignins, condensed naphthalenesulfonates, naphthalenesulfonates, alkylbenzenesulfonates, alkyl sulfates, or nonionic surfactants such as ethylene oxide adducts of alkyl phenols.

The pesticidal composition may be applied as an emulsifiable concentrate. An emulsifiable concentrate of the pesticidal composition may comprise the pesticidal composition, such as from about 50 to about 500 g/L of liquid dissolved in a carrier that is either a water miscible solvent or a mixture of water-immiscible organic solvent and emulsifiers. Non-limiting examples of useful organic solvents may include, but are not limited to, aromatics such as xylenes; petroleum fractions such as the high-boiling naphthalenic; olefinic portions of petroleum such as heavy aromatic naphtha; terpenic solvents such as rosin derivatives; aliphatic ketones such as cyclohexanone; and complex alcohols such as 2-ethoxyethanol. Suitable emulsifiers for emulsifiable concentrates may be chosen from conventional anionic and nonionic surfactants.

The pesticidal composition may be applied as an aqueous dispersible formulation. An aqueous dispersible formulation may comprise a suspension of water-insoluble pesticidal composition dispersed in an aqueous carrier at a concentration in the range from about 5% to about 50% by weight. Dispersions may be prepared by finely grinding the pesticidal composition and vigorously mixing it into a carrier comprised of water and surfactants. Ingredients, such as inorganic salts and synthetic or natural gums, may also be added, to increase the density and viscosity of the aqueous carrier. It is often most effective to grind and mix the pesticidal composition at the same time by preparing the aqueous mixture and homogenizing it in an implement such as a sand mill, ball mill, or piston-type homogenizer.

The pesticidal composition may be applied as a granular formulation. A granular formulation may contain from about 0.5% to about 10% by weight of the pesticidal composition, based on the total weight of the granular formulation. The pesticidal composition may be dispersed in an inert carrier which consists entirely or in large part of coarsely divided inert material such as attapulgite, bentonite, diatomite, clay or a similar inexpensive substance. In some embodiments, a granular formulation may be prepared by diluting the pesticidal composition in a suitable solvent and applying it to a granular carrier which has been preformed to the appropriate particle size, in the range of from about 0.5 millimeters (mm) to about 3 mm. A suitable solvent is a solvent in which the pesticidal compound is substantially or completely soluble. In some embodiments, granular formulation may be prepared by making a dough or paste of the carrier, the pesticidal composition and solvent, then crushing and drying the dough or paste to obtain the desired granular particles.

The pesticidal composition may be applied as a water dispersible granule, or dry flowable formulation. A water dispersible granules may include from about 10% to about 70% by weight of the pesticidal composition, based on the total weight of the water dispersible granule. Such water dispersible granule may be obtained through mixing and/or spraying the pesticidal composition onto a carrier with the addition of a dispersing and/or wetting agent, and combining with water to form a mixture suitable for further processing using known granulation technologies, such as pan granulation, extrusion, spray-drying, fluid bed agglomeration, and the like.

The pesticidal composition may be applied as a dust. In some embodiments, dust containing the disclosed pesticidal composition may be prepared by intimately mixing the pesticidal composition with a suitable dusty agricultural carrier. Non-limiting examples of such dusty agricultural carriers may include, but are not limited to, kaolin clay, ground volcanic rock, and the like. Dust may contain from about 1% to about 10% by weight of the pesticidal composition, based on the total weight of the dust. In some embodiments, dust may be prepared by impregnating the pesticidal composition onto a carrier in a similar manner to that described for granule above.

The pesticidal composition may be applied in the form of a solution in an appropriate organic solvent. By way of non-limiting examples, such organic solvents may include, but are not limited to, petroleum oils or spray oils.

In some embodiments, the pesticidal composition may be applied in conjunction with another active formulation that comprises one or more of other insecticides or fungicides or herbicides, in order to obtain control of a wider variety of pests, diseases or weeds. Another active formulation may be one of the components used for formulating the pesticidal composition. Alternatively, another active formulation may be post-added to the pesticidal composition. Furthermore, the pesticidal composition may be applied at the same time as another active formulation, or applied sequentially with another active formulation.

Insecticides that may be employed beneficially in conjunction with the pesticidal composition may include, but are not limited to: AIGA compounds, antibiotic insecticides such as allosamidin and thuringiensin; macrocyclic lactone insecticides such as spinosad, spinetoram, and other spinosyns including the 21-butenyl spinosyns and their derivatives; avermectin insecticides such as abamectin, doramectin, emamectin, eprinomectin, ivermectin and selamectin; milbemycin insecticides such as lepimectin, milbemectin, milbemycin oxime and moxidectin; arsenical insecticides such as calcium arsenate, copper acetoarsenite, copper arsenate, lead arsenate, potassium arsenite and sodium arsenite; biological insecticides such as Bacillus popilliae, B. sphaericius, B. thurinigiensis subsp. aizqwai, B. thuringiensis subsp. kurstaki, B. thuriugiensis subsp. tenebrionis, Beauveria bassiana, Cydia pomonella granulosis virus, Douglas fir tussock moth nuclear polyhedrosis virus NPV, gypsy moth NPV, Helicoverpa zea NPV, Indian meal moth granulosis virus, Metarhizium anisopliae, Nosema locustae, Paecilomyces fumosoroseus, P. lilacinus, Photorhabdus luminescens, Spodoptera exigua NPV, trypsin modulating oostatic factor, Xenorhabdus nematophilus, and X. bovienii; plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon di sulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as alpha-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methyl sulphon, disulfoton, ethion, ethoprophos, PSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temnephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetronic acid insecticides such as spirodiclofen, spiromesifen and spirotetramat; thiourea insecticides such as diafenthiuron; urea insecticides such as flucofuron and sulcofuron; and unclassified insecticides such as AKD-3088, closantel, crotamiton, cyflumetofen, E2Y45, EXD, fenazaflor, fenazaquin, fenoxacrim, fenpyroximate, FKI-1033, flubendiamide, HGW86, hydramethylnon, isoprothiolane, malonoben, metaflumizone, metoxadiazone, nifluridide, NNI-9850, NNI-0101, pymetrozine, pyridaben, pyridalyl, Qcide, rafoxanide, rynaxypyr, SYJ-159, triarathene and triazamate and any combinations thereof.

Non-limiting examples of fungicides that may be used beneficially in conjunction with the pesticidal composition may include, but are not limited to: AIGA compounds, 2-(thiocyanatomethylthio)-benzothiazole, 2-phenylphenol, 8-hydroxyquinoline sulfate, Ampelomyces quisqualis, azaconazole, azoxystrobin, Bacillus subtilis, benalaxyl, benomyl, benthiavalicarb-isopropyl, benzylaminobenzene-sulfonate (BABS) salt, bicarbonates, biphenyl, bismerthiazol, bitertanol, blasticidin-S, borax, Bordeaux mixture, boscalid, bromuconazole, bupirimate, calcium polysulfide, captafol, captan, carbendazim, carboxin, carpropamid, carvone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquation, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fentin, fentin acetate, fentin hydroxide, ferbam, ferimzone, fluazinam, fludioxonil, flumorph, fluopicolide, fluoroimide, fluoxastrobin, fluquinconazole, flusilazole, flusulfamide, flutolanil, flutriafol, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), ipconazole, iprobenfos, iprodione, iprovalicarb, isoprothiolane, kasugamycin, kasugamycin hydrochloride hydrate, kresoxim-methyl, mancopper, mancozeb, maneb, mepanipyrim, mepronil, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrazophos, pyributicarb, pyrifenox, pyrimethanil, pyroquilon, quinoclamine, quinoxyfen, quintozene, Reynoutria sachalinensis extract, silthiofam, simeconazole, sodium 2-phenylphenoxide, sodium bicarbonate, sodium pentachlorophenoxide, spiroxamine, sulfur, SYP-Z071, tar oils, tebuconazole, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, vinclozolin, zineb, ziram, zoxamide, Candida oleophila, Fusarium oxysporum, Gliocladium spp., Phlebiopsis gigantean, Streptomyces griseoviridis, Trichoderma spp., (RS)—N-(3,5-dichlorophenyl)-2-(methoxymethyl)-succinimide, 1,2-dichloropropane, 1,3 -dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme: ampropylfos, anilazine, azithiram, barium polysulfide, Bayer 32394, benodanil, benquinox, bentaluron, benzamacril; benzamacril-isobutyl, benzamorf, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluene sulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, XRD-563, and zarilamid, and any combinations thereof.

Herbicides that may be employed in conjunction with the pesticidal compositions may include, but are not limited to: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchior, thenylchlor and xylachlor; sulfonanilide herbicides such as benzofluor, perfluidone, pyrimisulfan and profluazol; sulfonamide herbicides such as asulam, carbasulam, fenasulam and oryzalin; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as benzfendizone, cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glyphosate and piperophos; phenoxy herbicides such as bromofenoxim, clomeprop, 2,4-DEB, 2,4-DEP, difenopenten, disul, erbon, etnipromid, fenteracol and trifopsime; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazolyl herbicides such as benzofenap, pyrazolynate, pyrasulfotole, pyrazoxyfen, pyroxasulfone and topramezone; pyrazolyiplpiethyl herbicides such as fluazolate and pyraflufen; pyridamine herbicides such as credazine, pyridafol and pyridate; pyridazitiotte herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluoroxypyr, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as butafenacil, bromacil, flupropacil, isocil, lenacil and terbacil; 3-phenyluracils; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluoron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac.

The pesticidal composition may be used for controlling a variety of pests.

In a particular embodiment, the pesticidal composition may be used to control pests in the Phyla Nematoda and/or Arthropoda. In another embodiment, the pesticidal composition may be used to control pests in the Subphyla Chelicerata, Myriapoda, and/or Hexapoda. In yet another embodiment, the pesticidal composition may be used to control pests in the Classes of Arachnida, Symphyla, and/or Insecta. In an alternate embodiment, the pesticidal composition may be used to control pests of the Order Homoptera.

In another embodiment, the pesticidal composition may be used to control pests of the Order Anoplura. Non-limiting examples of genera may include, but are not limited to, Haematopinus spp., Hoplopleura spp., Linognathus spp., Pediculus spp., and Polyplax spp. Non-limiting examples of species may include, but are not limited to, Haematopinus asini, Haematopinus suis, Linognathus setosus, Linognathus ovillus, Pediculus humanus capitis, Pediculus humanus humanus, and Pthirus pubis.

In yet another embodiment, the pesticidal composition may be used to control pests in the Order Coleoptera. Non-limiting examples of genera may include, but are not limited to, Acanthoscelides spp., Agriotes spp., Anthonomus spp., Apion spp., Apogonia spp., Aulacophora spp., Bruchus spp., Cerosterna spp., Cerotoma spp., Ceutorhynchus spp., Chaetocnema spp., Colaspis spp., Ctenicera spp., Curculio spp., Cyclocephala spp., Diabrotica spp., Hypera spp., Ips spp., Lyctus spp., Megascelis spp., Meligethes spp., Otiorhynchus spp., Pantomorus spp., Phyllophaga spp., Phyllotreta spp., Rhizotrogus spp., Rhynchites spp., Rhynchophorus spp., Scolytus spp., Sphenophorus spp., Sitophilus spp., and Tribolium spp. Non-limiting examples of species may include, but are not limited to, Acanthoscelides obtectus, Agrilus planipennis, Anoplophora glabripennis, Anthonomus grandis, Ataenius spretulus, Atomaria linearis, Bothynoderes punctiventris, Bruchus pisorum, Callosobruchus maculatus, Carpophilus hemipterus, Cassida vittata, Cerotoma trifurcata, Ceutorhynchus assimilis, Ceutorhynchus napi, Conoderus scalaris, Conoderus stigmosus, Conotrachelus nenuphar, Cotinis nitida, Crioceris asparagi, Cryptolestes ferrugineus, Cryptolestes pusillus, Cryptolestes turcicus, Cylindrocopturus adspersus, Deporaus marginatus, Dermestes lardarius, Dermestes maculatus, Epilachna varivestis, Faustinus cubae, Hylobius pales, Hypera postica, Hypothenemus hampei, Lasioderma serricorne, Leptinotarsa decemlineata, Liogenys fuscus, Liogenys suturalis, Lissorhoptrus oryzophilus, Maecolaspis joliveti, Melanotus communis, Meligethes aeneus, Melolontha melolontha, Oberea brevis, Oberea linearis, Oryctes rhinoceros, Oryzaephilus mercator, Oryzaephilus surinamensis, Oulema melanopus, Oulema oryzae, Phyllophaga cuyabana, Popillia japonica, Prostephanus truncatus, Rhyzopertha dominica, Sitona lineatus, Sitophilus granarius, Sitophilus oryzae, Sitophilus zeamais, Stegobium paniceum, Tribolium castaneum, Tribolium confusum, Trogoderma variabile, and Zabrus tenebrioides.

In an alternative embodiment, the pesticidal composition may be used to control pests of the Order Dermaptera.

In another embodiment, the pesticidal composition may be used to control pests of the Order Blattaria. Non-limiting examples of species may include, but are not limited to, Blattella germanica, Blatta orientalis, Parcoblatta pennsylvanica, Periplaneta americana, Periplaneta australasiae, Periplaneta brunnea, Periplaneta fuliginosa, Pycnoscelus surinamensis, and Supella longipalpa.

In yet another embodiment, the pesticidal composition may be used to control pests of the Order Diptera. Non-limiting examples of genera may include, but are not limited to, Aedes spp., Agromyza spp., Anastrepha spp., Anopheles spp., Bactrocera spp., Ceratitis spp., Chrysops spp., Cochliomyia spp., Contarinia spp., Culex spp., Dasineura spp., Delia spp., Drosophila spp., Fannia spp., Hylemyia spp., Liriomyza spp., Musca spp., Phorbia spp., Tabanus spp., and Tipula spp. Non-limiting examples of species may include, but are not limited to, Agromyza frontella, Anastrepha suspensa, Anastrepha ludens, Anastrepha obliqa, Bactrocera cucurbitae, Bactrocera dorsalis, Bactrocera invadens, Bactrocera zonata, Ceratitis capitata, Dasineura brassicae, Delia platura, Fannia canicularis, Fannia scalaris, Gasterophilus intestinalis, Gracillia perseae, Haematobia irritans, Hypoderma lineatum, Liriomyza brassicae, Melophagus ovinus, Musca autumnalis, Musca domestica, Oestrus ovis, Oscinella frit, Pegomya betae, Psila rosae, Rhagoletis cerasi, Rhagoletis pomonella, Rhagoletis mendax, Sitodiplosis mosellana, and Stomoxys calcitrans.

In a particular embodiment, the pesticidal composition may be used to control pests of the Order Hemiptera. Non-limiting examples of genera may include, but are not limited to, Adelges spp., Aulacaspis spp., Aphrophora spp., Aphis spp., Bemisia spp., Ceroplastes spp., Chionaspis spp., Chrysomphalus spp., Coccus spp., Empoasca spp., Lepidosaphes spp., Lagynotomus spp., Lygus spp., Macrosiphum spp., Nephotettix spp., Nezara spp., Philaenus spp., Phytocoris spp., Piezodorus spp., Planococcus spp., Pseudococcus spp., Rhopalosiphum spp., Saissetia spp., Therioaphis spp., Toumeyella spp., Toxoptera spp., Trialeurodes spp., Triatoma spp. and Unaspis spp. Non-limiting examples of species may include, but are not limited to, Acrosternum hilare, Acyrthosiphon pisum, Aleyrodes proletella, Aleurodicus dispersus, Aleurothrixus floccosus, Amrasca biguttula biguttula, Aonidiella aurantii, Aphis gossypii, Aphis glycines, Aphis pomi, Aulacorthum solani, Bemisia argentifolii, Bemisia tabaci, Blissus leucopterus, Brachycorynella asparagi, Brevennia rehi, Brevicoryne brassicae, Calocoris norvegicus, Ceroplastes rubens, Cimex hemipterus, Cimex lectularius, Dagbertus fasciatus, Dichelops furcatus, Diuraphis noxia, Diaphorina citri, Dysaphis plantaginea, Dysdercus suturellus, Edessa meditabunda, Eriosoma lanigerum, Eurygaster maura, Euschistus heros, Euschistus servus, Helopeltis antonii, Helopeltis theivora, Icerya purchasi, Idioscopus nitidulus, Laodelphax striatellus, Leptocorisa oratorius, Leptocorisa varicornis, Lygus hesperus, Maconellicoccus hirsutus, Macrosiphum euphorbiae, Macrosiphum granarium, Macrosiphum rosae, Macrosteles quadrilineatus, Mahanarva frimbiolata, Metopolophium dirhodum, Mictis longicornis, Myzus persicae, Nephotettix cinctipes, Neurocolpus longirostris, Nezara viridula, Nilaparvata lugens, Parlatoria pergandii, Parlatoria ziziphi, Peregrinus maidis, Phylloxera vitifoliae, Physokermes piceae, Phytocoris californicus, Phytocoris relativus, Piezodorus guildinii, Poecilocapsus lineatus, P sallus vaccinicola, Pseudacysta perseae, Pseudococcus brevipes, Quadraspidiotus perniciosus, Rhopalosiphum maidis, Rhopalosiphum padi, Saissetia oleae, Scaptocoris castanea, Schizaphis graminum, Sitobion avenae, Sogatella furcifera, Trialeurodes vaporariorum, Trialeurodes abutiloneus, Unaspis yanonensis, and Zulia entrerriana.

In another embodiment, the pesticidal composition may be used to control pests of the Order Hymenoptera. Non-limiting examples of genera may include, but are not limited to, Acromyrmex spp., Atta spp., Camponotus spp., Diprion spp., Formica spp., Monomorium spp., Neodiprion spp., Pogonomyrmex spp., Polistes spp., Solenopsis spp., Vespula spp., and Xylocopa spp. Non-limiting examples of species may include, but are not limited to, Athalia rosae, Atta texana, Iridomyrmex humilis, Monomorium minimum, Monomorium pharaonis, Solenopsis invicta, Solenopsis geminata, Solenopsis molesta, Solenopsis richtery, Solenopsis xyloni, and Tapinoma sessile.

In an alternative embodiment, the pesticidal composition may be used to control pests of the Order Isoptera. Non-limiting examples of genera may include, but are not limited to, Coptotermes spp., Cornitermes spp., Cryptotermes spp., Heterotermes spp., Kalotermes spp., Incisitermes spp., Macrotermes spp., Marginitermes spp., Microcerotermes spp., Procornitermes spp., Reticulitermes spp., Schedorhinotermes spp., and Zootermopsis spp. Non-limiting examples of species may include, but are not limited to, Coptotermes curvignathus, Coptotermes frenchi, Coptotermes formosanus, Heterotermes aureus, Microtermes obesi, Reticulitermes banyulensis, Reticulitermes grassei, Reticulitermes flavipes, Reticulitermes hageni, Reticulitermes hesperus, Reticulitermes santonensis, Reticulitermes speratus, Reticulitermes tibialis, and Reticulitermes virginicus.

In another embodiment, the pesticidal composition may be used to control pests of the Order Lepidoptera. Non-limiting examples of genera may include, but are not limited to, Adoxophyes spp., Agrotis spp., Argyrotaenia spp., Cacoecia spp., Caloptilia spp., Chilo spp., Chrysodeixis spp., Colias spp., Crambus spp., Diaphania spp., Diatraea spp., Earias spp., Ephestia spp., Epimecis spp., Feltia spp., Gortyna spp., Helicoverpa spp., Heliothis spp., Indarbela spp., Lithocolletis spp., Loxagrotis spp., Malacosoma spp., Peridroma spp., Phyllonorycter spp., Pseudaletia spp., Sesamia spp., Spodoptera spp., Synanthedon spp., and Yponomeuta spp. Non-limiting examples of species may include, but are not limited to, Achaea janata, Adoxophyes orana, Agrotis ipsilon, Alabama argillacea, Amorbia cuneana, Amyelois transitella, Anacamptodes defectaria, Anarsia lineatella, Anomis sabulifera, Anticarsia gemmatalis, Archips argyrospila, Archips rosana, Argyrotaenia citrana, Autographa gamma, Bonagota cranaodes, Borbo cinnara, Bucculatrix thurberiella, Capua reticulana, Carposina niponensis, Chlumetia transversa, Choristoneura rosaceana, Cnaphalocrocis medinalis, Conopomorpha cramerella, Cossus cossus, Cydia caryana, Cydia funebrana, Cydia molesta, Cydia nigricana, Cydia pomonella, Darna diducta, Diatraea saccharalis, Diatraea grandiosella, Earias insulana, Earias vittella, Ecdytolopha aurantianum, Elasmopalpus lignosellus, Ephestia cautella, Ephestia elutella, Ephestia kuehniella, Epinotia aporema, Epiphyas postvittana, Erionota thrax, Eupoecilia ambiguella, Euxoa auxiliaris, Grapholita molesta, Hedylepta indicata, Helicoverpa armigera, Helicoverpa zea, Heliothis virescens, Hellula undalis, Keiferia lycopersicella, Leucinodes orbonalis, Leucoptera coffeella, Leucoptera malifoliella, Lobesia botrana, Loxagrotis albicosta, Lymantria dispar, Lyonetia clerkella, Mahasena corbetti, Mamestra brassicae, Maruca testulalis, Metisa plana, Mythimna unipuncta, Neoleucinodes elegantalis, Nymphula depunctalis, Operophtera brumata, Ostrinia nubilalis, Oxydia vesulia, Pandemis cerasana, Pandemis heparana, Papilio demodocus, Pectinophora gossypiella, Peridroma saucia, Perileucoptera coffeella, Phthorimaea operculella, Phyllocnistis citrella, Pieris rapae, Plathypena scabra, Plodia interpunctella, Plutella xylostella, Polychrosis viteana, Prays endocarpa, Prays oleae, Pseudaletia umpuncta, Pseudoplusia includens, Rachiplusia nu, Scirpophaga incertulas, Sesamia inferens, Sesamia nonagrioides, Setora nitens, Sitotroga cerealella, Sparganothis pilleriana, Spodoptera exigua, Spodoptera frugiperda, Spodoptera eridania, Thecla basilides, Tineola bisselliella, Trichoplusia ni, Tuta absoluta, Zeuzera coffeae, and Zeuzera pyrina.

In a particular embodiment, the pesticidal composition may be used to control pests of the Order Mallophaga. Non-limiting examples of genera may include, but are not limited to, Anaticola spp., Bovicola spp., Chelopistes spp., Goniodes spp., Menacanthus spp., and Trichodectes spp. Non-limiting examples of species may include, but are not limited to, Bovicola bovis, Bovicola caprae, Bovicola ovis, Chelopistes meleagridis, Goniodes dissimilis, Goniodes gigas, Menacanthus stramineus, Menopon gallinae, and Trichodectes canis.

In another embodiment, the pesticidal composition may be used to control pests of the Order Orthoptera. Non-limiting examples of genera may include, but are not limited to, Melanoplus spp., and Pterophylla spp. Non-limiting examples of species may include, but are not limited to, Anabrus simplex, Gryllotalpa africana, Gryllotalpa australis, Gryllotalpa brachyptera, Gryllotalpa hexadactyla, Locusta migratoria, Microcentrum retinerve, Schistocerca gregaria, and Scudderia furcata.

In yet another embodiment, the pesticidal composition may be used to control pests of the Order Siphonaptera. Non-limiting examples of species may include, but are not limited to, Ceratophyllus gallinae, Ceratophyllus niger, Ctenocephalides canis, Ctenocephalides felis, and Pulex irritans.

In an alternative embodiment, the pesticidal composition may be used to control pests of the Order Thysanoptera. Non-limiting examples of genera may include, but are not limited to, Caliothrips spp., Frankliniella spp., Scirtothrips spp., and Thrips spp. Non-limiting examples of species may include, but are not limited to, Frankliniella fusca, Frankliniella occidentalis, Frankliniella schultzei, Frankliniella williamsi, Heliothnps haemorrhoidalis, Rhipiphorothnps cruentatus, Scirtothrips citri, Scirtothrips dorsalis, and Taeniothrips rhopalantennalis, Thrips hawaiiensis, Thrips nigropilosus, Thrips orientalis, Thrips tabaci.

In another embodiment, the pesticidal composition may be used to control pests of the Order Thysanura. Non-limiting examples of genera may include, but are not limited to, Lepisma spp. and Thermobia spp.

In yet another embodiment, the pesticidal composition may be used to control pests of the Order Acarina. Non-limiting examples of genera may include, but are not limited to, Acarus spp., Aculops spp., Boophilus spp., Demodex spp., Dermacentor spp., Epitrimerus spp., Eriophyes spp., Ixodes spp., Oligonychus spp., Panonychus spp., Rhizoglyphus spp., and Tetranychus spp. Non-limiting examples of species may include, but are not limited to, Acarapis woodi, Acarus siro, Aceria mangiferae, Aculops lycopersici, Aculus pelekassi, Aculus schlechtendali, Amblyomma americanum, Brevipalpus obovatus, Brevipalpus phoenicis, Dermacentor variabilis, Dermatophagoides pteronyssinus, Eotetranychus carpini, Notoedres cati, Oligonychus coffeae, Oligonychus ilicis, Panonychus citri, Panonychus ulmi, Phyllocoptruta oleivora, Polyphagotarsonemus latus, Rhipicephalus sanguineus, Sarcoptes scabiei, Tegolophus perseaflorae, Tetranychus urticae, and Varroa destructor.

In a particular embodiment, the pesticidal composition may be used to control pest of the Order Symphyla. Non-limiting examples of species may include, but are not limited to, Scutigerella immaculata.

In another embodiment, the pesticidal composition may be used to control pests of the Phylum Nematoda. Non-limiting examples of genera may include, but are not limited to, Aphelenchoides spp., Belonolaimus spp., Criconemella spp., Ditylenchus spp., Heterodera spp., Hirschmanniella spp., Hoplolaimus spp., Meloidogyne spp., Pratylenchus spp., and Radopholus spp. Non-limiting examples of species may include, but are not limited to, Dirofilaria immitis, Heterodera zeae, Meloidogyne incognita, Meloidogyne javanica, Onchocerca volvulus, Radopholus similis, and Rotylenchulus reniformis.

The pesticidal composition may improve the stability of AIGA compound in soil and enhance the residue activities of AIGA compound in soil, while maintaining (if not enhancing) the pesticidal efficacy of AIGA compound. Enhancing the soil residues of AIGA compound in soil may depend on at least two factors: the types of soil conditioners, and the weight ratio of soil conditioner to AIGA compound.

Accordingly, in one particular embodiment, a method of controlling pest comprises applying a pesticidal composition to soil, wherein the pesticidal composition comprises at least one soil conditioner selected from the group consisting of organic soil conditioners, microorganisms, activators, and combinations thereof and an AIGA compound. The weight ratio of soil conditioner to AIGA compound is at least about 20:1, and particularly at least about 25:1.

It is understood that the weight ratio of soil conditioner to AIGA compound in the pesticidal composition may be varied depending on various factors, such as application need, use rate, desired level of pesticidal efficacies, mode of application, type of pests to be controlled, etc.

In EXAMPLES 1 and 2, infra, a yeast protein-surfactant complex ACCELL®-STR from Advanced BioCatalytics Corporation was used as an organic soil conditioner. The yeast protein-surfactant complex ACCELL®-STR contains about 50% by volume of heat-shocked yeast Saccharomyces cerevisiae proteins ferment, about 25.00% by volume of sodium dioctylsulfosuccinate (DOSS, 75% solution), about 15% by volume of propylene glycol, and about 13% by volume of hexylene glycol.

The pesticidal compositions of EXAMPLES 1 and 2 were prepared by mixing a sulfoxaflor concentrate (240 g/L or 500 g/kg) with the yeast protein-surfactant complex ACCELL®-STR. It is understood that although the pesticidal compositions of EXAMPLES 1-5 use sulfoxaflor as the AIGA compound, other AIGA compounds may be used instead of sulfoxaflor, or may be used in combination with sulfoxaflor.

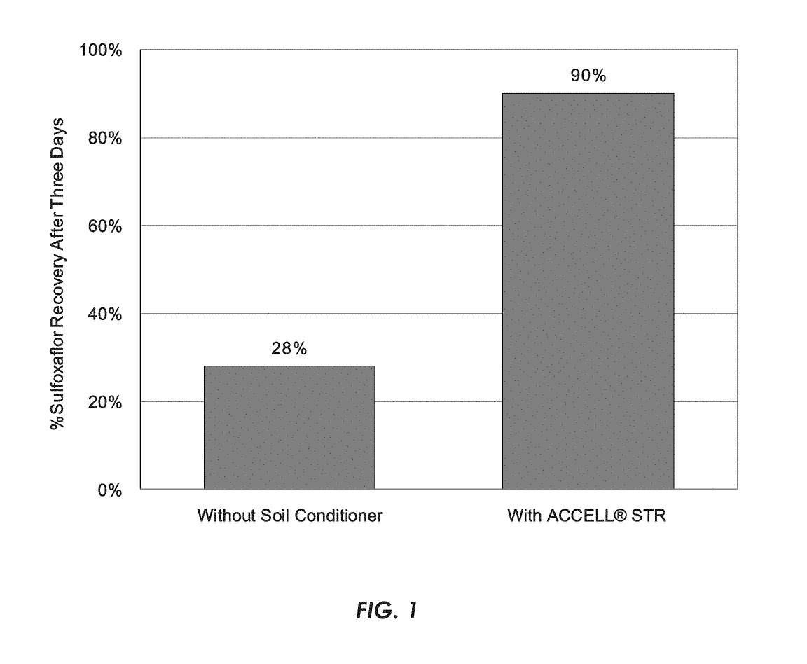

As shown in EXAMPLES 1 and 2, the pesticidal compositions show enhanced sulfoxaflor stability in soil, compared to a composition that contains sulfoxaflor but not soil conditioner. After an application to soil, the percentage of sulfoxaflor recovery of the pesticidal compositions in soil is much higher than that of a composition without the organic soil conditioner ACCELL®-STR. For example, EXAMPLE 1 and FIG. 1 show that at three days after applying to the inoculated soil from Fresno, Calif., the pesticidal compositions have more than three times higher in the % sulfoxaflor recovery compared to a control composition (i.e., a composition that contains sulfoxaflor but not the organic soil conditioner ACCELL®-STR). Thus, the pesticidal compositions may be effective and available for root uptake by the plant for a longer period after their application, compared to the similar composition that lacks the organic soil conditioner ACCELL®-STR.

It is surprising and unexpected that a significantly enhanced sulfoxaflor stability in soil may be achieved by including an organic soil conditioner, e.g., a yeast protein-surfactant complex ACCELL®-STR, in the pesticidal compositions.

Furthermore, the efficiency of the organic soil conditioner in increasing the sulfoxaflor stability depends on the compositions and physical properties of the soil. EXAMPLE 1 shows that for the treatment of inoculated soil from Fresno, Calif., the pesticidal compositions provide the % sulfoxaflor recovery that is more than three times higher than that of the control composition (i.e., a composition that contains sulfoxaflor but not the organic soil conditioner ACCELL®-STR). EXAMPLE 2 shows that for the treatment of inoculated Midwest soil, the pesticidal compositions provide the % sulfoxaflor recovery that is 1.7 times higher than that of the control composition.

Additionally, the enhancement of sulfoxaflor stability in soil depends on the types of soil conditioner. The organic soil conditioners (e.g., a yeast protein-surfactant complex ACCELL®-STR) substantially enhance the sulfoxaflor stability in soil. On the other hand, as shown in EXAMPLE 3, the inorganic soil conditioners (e.g., gypsum and perlite) marginally increase the sulfoxaflor stability in soil.

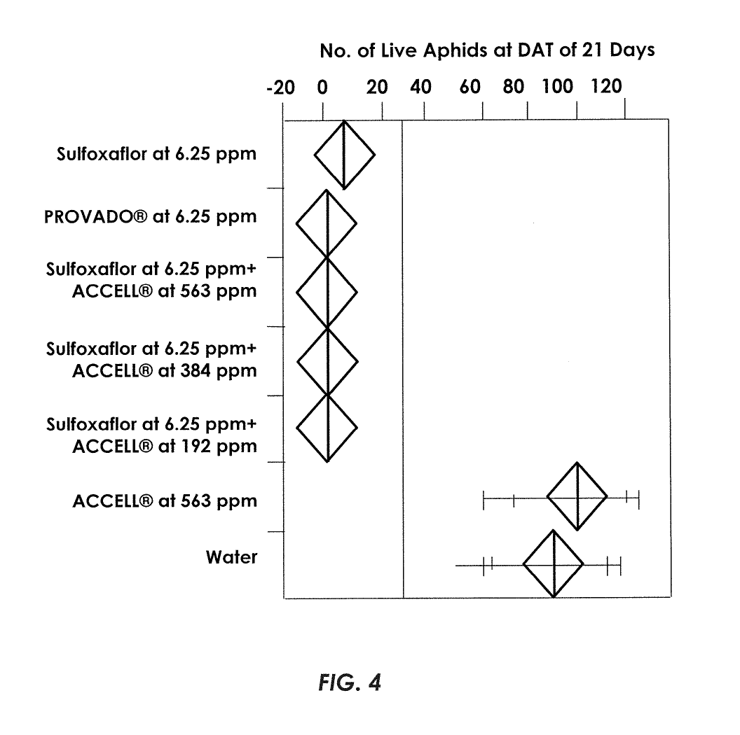

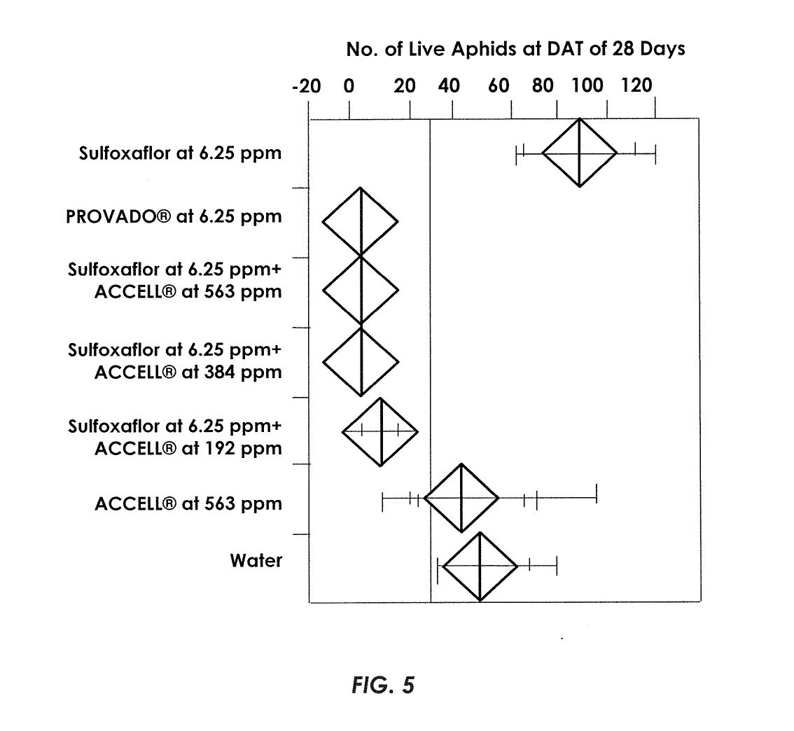

The present disclosure also envisages a method of controlling sap-feeding insects on the top part of plants by applying the pesticidal composition to the soil around the root system of the plant. EXAMPLE 4 shows the pesticidal activities against green peach aphid (Myzus persicae) when the soil around the root system of the plant is treated with the disclosed pesticidal compositions. As shown in FIGS. 4 and 5, the soil treatment using the pesticidal compositions (prepared by mixing a sulfoxaflor concentrate with an organic soil conditioner ACCELL®-STR) provides comparable pesticidal activities against green peach aphid (Myzus persicae) as a commercial imidacloprid pesticide (PROVADO® 1.6 pesticide from Bayer CropScience LP).

In embodiments, a dsRNA molecule may be formed by a single self-complementary RNA strand or from two complementary RNA strands. dsRNA molecules may be synthesized either in vivo or in vitro. An endogenous RNA polymerase of the cell may mediate transcription of the one or two RNA strands in vivo, or cloned RNA polymerase may be used to mediate transcription in vivo or in vitro. Post-transcriptional inhibition of a target gene in an insect pest may be host-targeted by specific transcription in an organ, tissue, or cell type of the host (e.g., by using a tissue-specific promoter); stimulation of an environmental condition in the host (e.g., by using an inducible promoter that is responsive to infection, stress, temperature, and/or chemical inducers); and/or engineering transcription at a developmental stage or age of the host (e.g., by using a developmental stage-specific promoter). RNA strands that form a dsRNA molecule, whether transcribed in vitro or in vivo, may or may not be polyadenylated, and may or may not be capable of being translated into a polypeptide by a cell's translational apparatus.

Furthermore, TABLES 3-8 of EXAMPLE 4 shows that the pesticidal compositions may provide a synergistic pesticidal effect between sulfoxaflor and the organic soil conditioner ACCELL®-STR against green peach aphid (Myzus persicae) on the top part of plants, when the pesticidal compositions are applied to the soil around the root system of the plants.

The following examples serve to explain embodiments of the present disclosure in more detail. These examples are not to be construed as being exhaustive or exclusive as to the scope of this disclosure.

### EXAMPLES

### Example 1

### Effects of Organic Soil Conditioner ACCELL®-STR on Sulfoxaflor Stability in Inoculated Soil from Fresno, Calif.

Inoculated soil from Fresno, Calif. was analyzed for the soil moisture using Mettler LJ16 Moisture Analyzer (15 minutes and 100° C.). For a consistent test protocol, the soil was dried at room temperature to about 8% initial soil moisture level. Then, the dry soil mass was calculated based on soil moisture. For the Fresno soil, moisture between 26% and 30% is normally recommended. Therefore, 26% (i.e., 260,000 ppm) soil moisture was used for tests.

Sulfoxaflor formulations used in the study were CLOSER® SC insecticide from Dow AgroSciences, which has a sulfoxaflor concentration of 240 g/L (about 21.8% active sulfoxaflor); and TRANSFORM® WG insecticide also from Dow AgroSciences, which is a sulfoxaflor water dispersible granule formulation (WDG) having a sulfoxaflor concentration of 500 g/kg. A 500 ppm sulfoxaflor active solution was prepared by diluting the CLOSER® SC insecticide (240 g/L sulfoxaflor SC) or the TRANSFORM® WG insecticide (500 g/kg sulfoxaflor WDG) with deionized water.

Sulfoxaflor dose of about 6.25 ppm of sulfoxaflor active per gram of the final soil mixture (8.44 ppm of active per gram of dry soil mass) was used as a standard application rate for EXAMPLE 1.

Soil Conditioner used for the study was a yeast protein-surfactant complex ACCELL®-STR from Advanced BioCatalytics Corporation (Irvine, Calif.), which contained about 48.54% by volume of heat-shocked yeast Saccharomyces cerevisiae proteins ferment, about 25.00% by volume of sodium dioctylsulfosuccinate (DOSS, 75% solution), about 13.18% by volume of propylene glycol, and about 12.5% by volume of hexylene glycol.

Soil conditioner dose of about 384 ppm of the yeast protein-surfactant complex ACCELL®-STR soil conditioner per gram of final soil mixture was tested (384 μg soil conditioner per gram of final soil mixture; 1500 ppm of soil conditioner per gram of total soil liquid; 526 μg of soil conditioner per gram of dry soil mass).

A control composition was the composition that included the sulfoxaflor concentrate (CLOSER® SC insecticide or TRANSFORM® WG insecticide) but not the organic soil conditioner ACCELL®-STR.

A control soil sample was the soil sample treated with the control composition. The control soil sample was run with each test for comparison, and was recorded as “Without Soil Conditioner” sample.

All tests were measured under the following conditions:

About 15 grams of inoculated Fresno soil was measured by Mettler AE20 Analytical Balance, and added into a 30 milliliter (mL) Nalgene Wide-Mouth HDPE plastic bottle. The sulfoxaflor solution, organic soil conditioner ACCELL®-STR, and additional water were added into the plastic bottle to achieve 6.25 ppm sulfoxaflor active, 384 ppm organic soil conditioner ACCELL®-STR, and 260,000 ppm water per gram of final soil mixture.

Each of the tested soil samples (including the control soil sample) was left under the same conditions for three days. After three days, the % sulfoxaflor recovery in the tested soils was determined using the following extraction procedure:

Sulfoxaflor was extracted from soil by adding 10 mL of acetonitrile with 0.01% formic acid. Two 12 mm glass beads were placed into the plastic bottle which was then shaken by hand until it was roughly homogeneous. The bottle was then shaken on high speed with a horizontal shaker for one hour (Eberbach Reciprocating Shaker 6010). About 10 mL of the extract was centrifuged for 7 minutes at 3000 rpm (Beckman J2-MI). The supernant was filtered with a 0.2 micron filter (Pall PTFE). About 750 microliters (μL) of the filtered extract and 25 μL of 4-ethylphenol (0.323 mg/mL of methanol) was added to a 2 mL glass autosampler vial with a micropipette (Evol by SGE Analytical).

FIG. 1 shows the % sulfoxaflor recovery after three days for the soil sample treated with the pesticidal composition that included about 6.25 ppm sulfoxaflor and about 384 ppm of organic soil conditioner ACCELL®-STR per final soil mixture. For comparison, FIG. 1 also shows the % sulfoxaflor recovery for the control soil sample (the soil sample treated with the control pesticidal composition; “Without Soil Conditioner” sample).

As shown in FIG. 1, when the inoculated soil from Fresno, Calif. was treated with the pesticidal composition including 6.25 ppm sulfoxaflor and 384 ppm organic soil conditioner ACCELL®-STR (“With ACCELL® STR” sample), about 90% of sulfoxaflor was recovered three days after the soil treatment. On the other hand, only 28% of sulfoxaflor was recovered in the control soil sample (“Without Soil Conditioner” sample). Thus, when about 384 ppm of the organic soil conditioner ACCELL®-STR was included into the pesticidal composition for the soil treatment, the % recovery of sulfoxaflor was about 3.2 times higher than that obtained from the control soil sample.

### Example 2

### Effect of Organic Soil Conditioner ACCELL®-STR on the Sulfoxaflor Stability in Inoculated Midwest Soil

Inoculated Midwest field soil was treated with the pesticidal compositions using the same protocol as described in EXAMPLE 1.

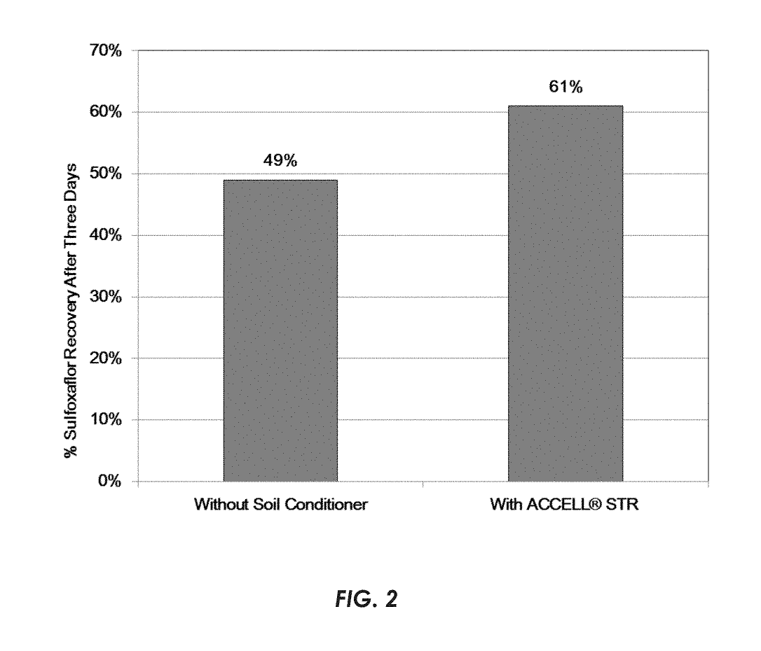

FIG. 2 shows the % sulfoxaflor recovery after three days for the inoculated Midwest soil treated with the composition that included about 6.25 ppm sulfoxaflor and about 384 ppm soil conditioner ACCELL®-STR (“With ACCELL® STR” sample). For comparison, FIG. 2 also shows the % sulfoxaflor recovery for the control soil sample (the soil sample treated with the control pesticidal composition; “Without Soil Conditioner” sample).

As shown in FIG. 2, at three weeks after the soil treatment about 49% of sulfoxaflor was recovered in the control soil sample (“Without Soil Conditioner” sample). For the soil sample that was treated with the pesticidal composition containing about 6.25 ppm sulfoxaflor and about 384 ppm soil conditioner ACCELL®-STR (“With ACCELL® STR” sample), about 61% of sulfoxaflor was recovered, which was about 1.7 times higher than the sulfoxaflor recovery in the control “Without Soil Conditioner” sample.

### Example 3

### Effect of Inorganic Soil Conditioners (Gypsum and Perlite) on Sulfoxaflor Stability in Inoculated Midwest Soil

Inoculated Midwest field soil was treated with the tested compositions using the same protocol as described in EXAMPLE 1. Two commonly used inorganic soil conditioners (gypsum and perlite) were investigated for their effect on the sulfoxaflor stability in soil. Gypsum used in the present study was from Agri Marketing, Inc. (dba USA Gypsum). Perlite was MIRACLE-GRO® Perlite available from MIRACLE-GRO® Law Products, Inc. When the composition included the inorganic soil conditioner, the composition contained about 6.5 ppm sulfoxaflor and about 384 ppm of inorganic soil conditioner. The control sample (“Without Soil Conditioner” sample) was the soil sample treated with a control composition (i.e., a composition containing about 6.5 ppm sulfoxaflor per final soil mixture but not an inorganic soil conditioner).

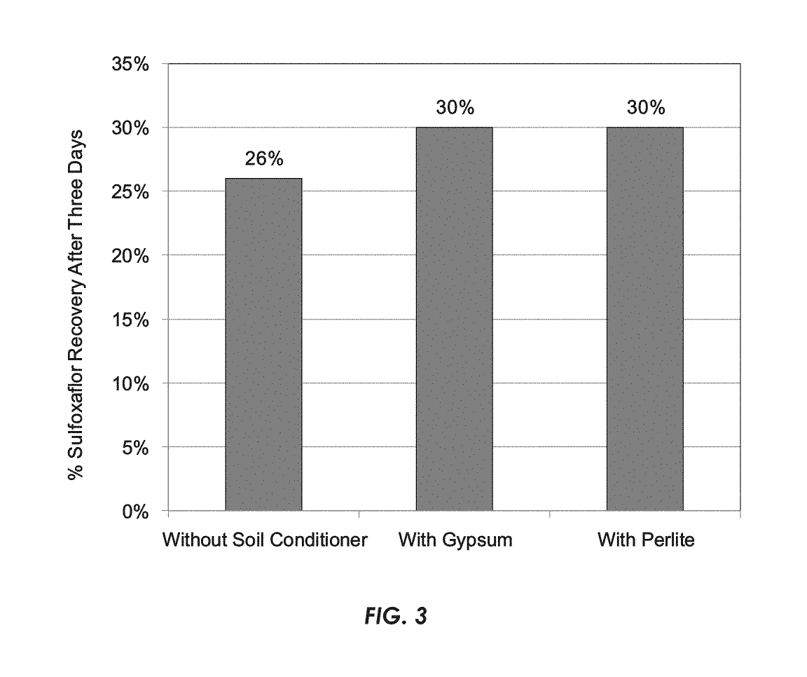

As shown in FIG. 3, after three days about 26% of sulfoxaflor was recovered in the control soil sample (“Without Soil Conditioner” sample). For the soil sample that was treated with the pesticidal composition containing about 6.5 ppm sulfoxaflor and about 384 ppm gypsum as an inorganic soil conditioner (“With Gypsum” sample), the % sulfoxaflor recovery after three days was about 30%. For the soil sample that was treated with the pesticidal composition containing about 6.5 ppm sulfoxaflor and about 384 ppm perlite as an inorganic soil conditioner (“With Perlite” sample), the % sulfoxaflor recovery after three days was about 30%. Thus, % sulfoxaflor recovery was about the same (i.e., within an experimental error) whether the composition included the inorganic soil conditioner or not. Therefore, in this study the inorganic soil conditioners (gypsum and perlite) marginally enhanced (if at all) the sulfoxaflor stability in soil.

### Example 4

### Pesticidal Activities Against Green Peach Aphid (Myzus persicae) Preparation of Tested Compositions

Each tested compositions was prepared by mixing a predetermined amount of the CLOSER® SC insecticide (a sulfoxaflor concentrate having a sulfoxaflor concentration of 240 g/L) with a predetermined amount of the organic soil conditioner ACCELL®-STR in an aqueous medium.

The compositions containing different amounts of sulfoxaflor and the organic soil conditioner ACCELL®-STR were prepared as shown in TABLE 1. For example, the “Sulfoxaflor at 6.25 ppm” composition contained about 0.003% weight of sulfoxaflor based on total weight of the composition (i.e., 6.25 ppm of sulfoxaflor per one gram of final soil mixture). “Sulfoxaflor at 6.25 ppm+ACCELL®-STR at 384 ppm” composition contained about 0.003% weight of sulfoxaflor based on total weight of the composition (i.e., 6.25 ppm of sulfoxaflor per one gram of final soil mixture), and about 0.225% weight of the organic soil conditioner ACCELL®-STR based on total weight of the composition (i.e., 384 ppm per one gram of the final soil mixture; 1500 ppm per one gram of the total soil liquid).

TABLE 1
Amounts of sulfoxaflor and the organic soil conditioner ACCELL ®-STR in
the tested compositions

| | Amount of the Component | |
|---|---|---|
| | (% wt based on total composition weight) | |
| Tested Composition | | Organic Soil Conditioner |
| (as labeled in FIG. 4) | Sulfoxaflor | ACCELL ®-STR |
| Sulfoxaflor at 6.25 ppm | 0.003% | None |
| Sulfoxaflor at 6.25 ppm + ACCELL ® at 563 ppm | 0.003% | 0.329% |
| Sulfoxaflor at 6.25 ppm + ACCELL ® at 384 ppm | 0.003% | 0.225% |
| Sulfoxaflor at 6.25 ppm + ACCELL ® at 192 ppm | 0.003% | 0.112% |

The imidacloprid pesticide PROVADO® 1.6 from Bayer CropScience LP (North Carolina, USA) was used as a standard commercial pesticidal composition for aphid control. The imidacloprid pesticide PROVADO® 1.6 was tested at the same loading as that used for the sulfoxaflor, which was 6.25 ppm per gram of final soil mixture.

In this EXAMPLE 4, water was tested as a control composition. Furthermore, an aqueous solution of the organic soil conditioner ACCELL®-STR was tested.

### Determination of Pesticidal Activities Against Green Peach Aphid

Cabbage plants (Brassica oleracea capitata L) of uniform size (two new leaf stage) infested with green peach aphids (Myzus persicae) (“GPA”) were used as the study models according to the following procedure:

Cabbage seeds were planted in 3-inch pots containing a peat-based METRO MIX 360® potting soil available from SUN GRO® Horticulture Canada, Ltd. The seeds were propagated in greenhouse zone G4, located in the R&D building of Dow AgroSciences (Indianapolis, Ind., USA), at 26° C. with a relative humidity of 53%. Natural light was supplemented with 1,000-watt metal halide overhead lamps with an average illumination of about 500 μE/m².s photosynthetic active radiation for 16 consecutive hours each day.

Each of the 1-ounce clear cups was filled with about 30 grams of the inoculated Midwest field soil having the components as shown in TABLE 2. The Midwest soil was a silt loam soil that was collected from Fowler Field Station (Fowler, Ind.), and had a pH of about 6.9. The soil moisture of the Midwest field soil was about 15% as measured by Mettler LJ16 Moisture Analyzer (15 minutes and 100° C.).

TABLE 2
Components of the Midwest Soil Used for the Study

| Component | Amount |
|---|---|
| Organic Matter | 3.9% by L.O.I. |
| Available Phosphorus | 22 ppm (M) |
| Potassium | 1.1%; 84 ppm (L) |
| Magnesium | 28.5%; 670 (VH) |
| Calcium | 68.9%; 2500 (H) |
| Hydrogen | 1.5% |
| Sands | 35% |
| Silt | 35% |
| Clay | 30% |

The Midwest field soil in each selected 1-ounce cup was treated with about 9 mL of the selected composition using a 10 mL pipette. Deionized water was used as a control. The remainders of the 1-ounce cups were capped, and a small hole was poked into each lid to provide air flow. The remainders of the 1-ounce cups were stored in a controlled environment at 26° C. and covered with a black plastic bag to prevent any light from entering, until being used for the test.

Cabbage plants were gently removed from the 3-inch pots, and the plant roots were washed with water to remove any excess soil. Then, the cabbage plant was transplanted into the 1-ounce cup containing the treated Midwest field soil (one cabbage plant per one 1-ounce cup). The plants were watered as needed after being transplanted.

At the selected number of days after treating the Midwest field soil with the composition (i.e., numbers of days after the soil treatment, “DAT”), the cabbage plants were transplanted in each 1-ounce cup and infested with GPA by placing a piece of squash leaf infested with about 25 aphids on each cabbage plant. The plants were then placed in a controlled environment at 26° C. for three days.

The pesticidal activity against GPA was determined three days after infestation, by counting the number of live GPA aphids present on each cabbage plant.

FIG. 4 showed the pesticidal activity against GPA at DAT of 21 days. The cabbages in the Midwest soil treated with the “Sulfoxaflor at 6.25 ppm” composition showed about 10 live GPA aphids. The cabbages in the Midwest soil treated with the composition comprising about 6.25 ppm of sulfoxaflor and the organic soil conditioner ACCELL®-STR showed no live GPA, regardless of the amount of organic soil conditioner ACCELL®-STR in the tested composition (i.e., 563 ppm, 384 ppm, or 192 ppm). The cabbages in the soil treated with commercial PROVADO® 1.6 pesticide at 6.25 ppm loading showed no live GPA aphid at DAT of 21 days. Thus, the compositions comprising sulfoxaflor and the organic soil conditioner ACCELL®-STR provided the same level of pesticidal activity against GPA as the commercial PROVADO® 1.6 pesticide (i.e., almost 100% control) at DAT of 21 days. The soil treated with water or with an aqueous solution of the organic soil conditioner ACCELL®-STR showed about the same level of live GPA, which were about 80 to about 100 live aphids.

FIG. 5 showed the pesticidal activity against GPA at DAT of 28 days. The cabbages in the Midwest soil treated with the “Sulfoxaflor at 6.25 ppm” composition showed about 90 live GPA aphids. The cabbages in the Midwest soil treated with the composition comprising about 6.25 ppm of sulfoxaflor and the organic soil conditioner ACCELL®-STR at either 563 ppm or 384 ppm showed no live GPA, which was the same result as that was observed for the commercial PROVADO® 1.6 pesticide at 6.25 ppm. The cabbages in the Midwest soil treated with the composition comprising about 6.25 ppm of sulfoxaflor and about 192 ppm of the organic soil conditioner ACCELL®-STR showed about 40 live GPA at 28 days after the soil treatment.

Thus, at DAT of 28 days, the soil treatment with the composition comprising about 6.25 ppm sulfoxaflor and the organic soil conditioner ACCELL®-STR at either 563 ppm or 384 ppm showed approximately the same level of pesticidal activity (%100 control) against GPA as that of commercial PROVADO® 1.6 pesticide.

Determination of Synergistic Effect of Sulfoxaflor and Organic Soil Conditioner ACCELL®-STR for the Soil Treatment Against Green Peach Aphid (Myzus persicae)

The method described in Colby S. R., Calculating Synergistic and Antagonistic Responses of Herbicide Combinations, Weeds, 1967, 15, 20-22 was used to determine an existence of synergistic effect between sulfoxaflor and the organic soil conditioner ACCELL®-STR in the composition for the soil treatment. In this method, the percent insect control of the composition as observed in the study was compared to the “expected” percent control (E) as calculated by equation (1) (hereinafter “Colby's equation”) below:

$$E = X + Y - ( \frac{XY}{100} ) \qquad ( 1 )$$

where
X is the percentage of control with sulfoxaflor at a given rate (p),
Y is the percentage of control with the organic soil conditioner ACCELL®-STR at a given rate (q), and
E is the expected control by sulfoxaflor and the organic soil conditioner ACCELL®-STR at a rate of p+q.

TABLE 3 shows the percent control of GPA when the Midwest field soil was treated with different compositions at DAT of 21 days. When the composition comprising about 6.25 ppm of sulfoxaflor and about 192 ppm of the organic soil conditioner ACCELL®-STR (i.e., 750 ppm per one gram of total soil liquid) was used for the soil treatment, the % control against GPA was determined as the “Observed” action, and compared to those obtained from the soil treatment using either 6.25 ppm of sulfoxaflor alone, or 192 ppm of the organic soil conditioner ACCELL®-STR alone. The “Colby's Expected Action” was calculated using Colby's equation as discussed previously.

TABLE 3
Pesticidal activities against green peach aphids (Myzus persicae) at 21
days after the soil treatment using sulfoxaflor loading of 6.25 ppm, with
or without 192 ppm of the organic soil conditioner ACCELL ®-STR

| | Dose Rate | % Control |
|---|---|---|
| Soil Treatment | (ppm) | at DAT of 21 days |
| Sulfoxaflor | 6.25 | 91.19 |
| ACCELL ®-STR soil conditioner | 192 | 0 |
| Sulfoxaflor + ACCELL ®-STR soil | 6.25 + 192 | 99.6 |
| conditioner | | |
| Colby's Expected Action | 6.25 + 192 | 91.2 |
| Differences: Observed vs. Expected | 6.25 + 192 | 8.4 |

As shown in TABLE 3, no control against GPA at DAT of 21 days was observed when the soils were treated with the organic soil conditioner ACCELL®-STR alone. The expected percentage control according to Colby's equation was calculation to be about 91.2. When the soil was treated with a composition comprising both sulfoxaflor and the organic soil conditioner ACCELL®-STR, about 99.6% control against GPA was observed, which was higher than the expected action according to Colby's equation. Thus, sulfoxaflor at 6.25 ppm and the organic soil conditioner ACCELL®-STR at 192 ppm showed a synergistic effect against GPA when used together in the composition for the soil treatment.

TABLE 4
Pesticidal activities against green peach aphids (Myzus persicae) at 21
days after the soil treatment using sulfoxaflor loading of 6.25 ppm, with
or without 384 ppm of the organic soil conditioner ACCELL ®-STR

| | Dose Rate | % Control |
|---|---|---|
| Soil Treatment | (ppm) | at DAT of 21 days |
| Sulfoxaflor | 6.25 | 91.19 |
| ACCELL ®-STR soil conditioner | 384 | 0 |
| Sulfoxaflor + ACCELL ®-STR soil | 6.25 + 384 | 100 |
| conditioner | | |
| Colby's Expected Action | 6.25 + 384 | 91.2 |
| Differences: Observed vs. Expected | 6.25 + 384 | 8.8 |

As shown in TABLE 4, about 100% control against GPA was observed at DAT of 21 days when the soil was treated with a composition comprising 6.25 ppm sulfoxaflor and 384 ppm of the organic soil conditioner ACCELL®-STR. No control against GPA was found when the soil was treated with the organic soil conditioner ACCELL®-STR alone. The expected percentage control according to Colby's equation was calculated to be about 91.2, which was lower than the observed action. Thus, sulfoxaflor at 6.25 ppm and the organic soil conditioner ACCELL®-STR at 384 ppm showed a synergistic effect against GPA when used together in the composition for the soil treatment.

TABLE 5
Pesticidal activities against green peach aphids (Myzus persicae) at 21
days after the soil treatment using sulfoxaflor loading of 6.25 ppm, with
or without 563 ppm of the organic soil conditioner ACCELL ®-STR

| | Dose Rate | % Control |
|---|---|---|
| Soil Treatment | (ppm) | at DAT of 21 days |
| Sulfoxaflor | 6.25 | 91.19 |
| ACCELL ®-STR soil conditioner | 563 | 0 |
| Sulfoxaflor + ACCELL ®-STR soil | 6.25 + 563 | 100 |
| conditioner | | |
| Colby's Expected Action | 6. 25 + 563 | 91.2 |
| Differences: Observed vs. Expected | 6.25 + 563 | 8.8 |

TABLE 5 showed that about 100% control against GPA was observed at DAT of 21 days when the soil was treated with a composition comprising 6.25 ppm sulfoxaflor and 563 ppm of the organic soil conditioner ACCELL®-STR, while no control (0%) was found when the soil was treated with the organic soil conditioner ACCELL®-STR alone. The expected percentage control according to Colby's equation was calculated to be about 91.2, which was lower than the observed action. Thus, sulfoxaflor at 6.25 ppm and the organic soil conditioner ACCELL®-STR at 563 ppm showed a synergistic effect against GPA when used together in the composition for the soil treatment.

TABLE 6
Pesticidal activities against green peach aphids (Myzus persicae) at 28
days after the soil treatment using sulfoxaflor loading of 6.25 ppm, with
or without 192 ppm of the organic soil conditioner ACCELL ®-STR

| | Dose Rate | % Control |
|---|---|---|
| Soil Treatment | (ppm) | at DAT of 28 days |
| Sulfoxaflor | 6.25 | 0 |
| ACCELL ®-STR soil conditioner | 192 | 15.63 |
| Sulfoxaflor + ACCELL ®-STR soil | 6.25 + 192 | 74.07 |
| conditioner | | |
| Colby's Expected Action | 6.25 + 192 | 15.6 |
| Differences: Observed vs. Expected | 6.25 + 192 | 58.4 |

As shown in TABLE 6, no control against GPA was observed at 28 days after treating the soils with the composition comprising only sulfoxaflor alone. When the soil was treated with the composition comprising the organic soil conditioner ACCELL®-STR alone, only about 15.63% control against GPA was found. The expected percentage control according to Colby's equation was calculated to be about 15.6. However, about 74.07% control against GPA was observed when the composition comprising both sulfoxaflor and the organic soil conditioner ACCELL®-STR, which was about 4.75 times higher than the expected action according to Colby's equation. It was surprising and unexpected that not only was there a synergistic effect against GPA between sulfoxaflor and the organic soil conditioner ACCELL®-STR when used together in the composition for the soil treatment, but also the large magnitude of such synergistic effect.

TABLE 7
Pesticidal activities against green peach aphids (Myzus persicae) at 28
days after the soil treatment using sulfoxaflor loading of 6.25 ppm, with
or without 384 ppm of the organic soil conditioner ACCELL ®-STR

| | Dose Rate | % Control |
|---|---|---|
| Soil Treatment | (ppm) | at DAT of 28 days |
| Sulfoxaflor | 6.25 | 0 |
| ACCELL ®-STR soil conditioner | 384 | 15.63 |
| Sulfoxaflor + ACCELL ®-STR soil | 6.25 + 384 | 100 |
| conditioner | | |
| Colby's Expected Action | 6.25 + 384 | 15.6 |
| Differences: Observed vs. Expected | 6.25 + 384 | 84.4 |

As shown in TABLE 7, when sulfoxaflor was used alone for the soil treatment, no control against GPA was observed. When the organic soil conditioner ACCELL®-STR was used alone for the soil treatment, about 15.63% control against GPA alphids was found at 28 days after the soil treatment. The expected percentage control according to Colby's equation was calculation to be about 15.6. However, a complete control (about 100%) against GPA was observed when the composition comprising both sulfoxaflor and the organic soil conditioner ACCELL®-STR, which was about 6.4 times higher than the expected action according to Colby's equation. Again, it was surprising and unexpected that not only was there a synergistic effect against GPA between sulfoxaflor and the organic soil conditioner ACCELL®-STR when used together in the composition for the soil treatment, but also the large magnitude of such synergistic effect.

TABLE 8
Pesticidal activities against green peach aphids (Myzus persicae) at 28
days after the soil treatment using sulfoxaflor loading of 6.25 ppm,
with or without 563 ppm of the yeast protein-surfactant complex
ACCELL ®-STR soil conditioner

| | Dose Rate | % Control |
|---|---|---|
| Soil Treatment | (ppm) | at DAT of 28 days |
| Sulfoxaflor | 6.25 | 0 |
| ACCELL ®-STR soil conditioner | 563 | 15.63 |
| Sulfoxaflor + ACCELL ®-STR soil | 6.25 + 563 | 99.54 |
| conditioner | | |
| Colby's Expected Action | 6.25 + 563 | 15.6 |
| Differences: Observed vs. Expected | 6.25 + 563 | 83.9 |

TABLE 8 showed that when sulfoxaflor was used alone for the soil treatment, no control against GPA was observed. When the organic soil conditioner ACCELL®-STR was used alone for the soil treatment, about 15.63% control against GPA alphids was found. The expected percentage control according to Colby's equation was calculation to be about 15.6. However, a nearly complete control (about 99.54%) against GPA was observed when the composition comprising both sulfoxaflor and the organic soil conditioner ACCELL®-STR, which was about 6.4 times higher than the expected action according to Colby's equation. Thus, a significant synergistic effect against GPA was observed when sulfoxalfor and organic soil conditioner ACCELL®-STR were used together in the composition for the soil treatment.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A pesticidal composition, comprising:
at least one soil conditioner selected from the group consisting of organic soil conditioners, microorganisms, activators, and combinations thereof,
an active ingredient group alpha (AIGA) compound; and
wherein the weight ratio of soil conditioner to AIGA compound is at least about 20:1.

2. The pesticidal composition of claim 1, wherein the weight ratio of soil conditioner to AIGA compound is at least about 25:1.

3. The pesticidal composition of claim 1, wherein the weight ratio of soil conditioner to AIGA compound is between about 100:1 and 20:1.

4. The pesticidal composition of claim 1, wherein the weight ratio of soil conditioner to sulfoxaflor is between about 65:1 and about 20:1.

5. The pesticidal composition of claim 1, wherein the AIGA compound comprises at least one of the following compounds:
an insecticide comprising acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor, thiacloprid, thiamethoxam, thiocyclam hydrogen oxalate, thiometon, thiometon sulfone, triazamate, or vamidothion; and
a fungicide comprising carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, or triadimefon.

6. The pesticidal composition of claim 1, wherein the soil conditioner comprises an organic soil conditioner selected from the group consisting of soil organic matters, humates, animal manures, green manure crops, crop residues, sawdust, waste organic matters, biochar, soya lecithin, yeast protein, yeast protein-surfactant complex, and combinations thereof

7. The pesticidal composition of claim 1, wherein the soil conditioner comprises a yeast protein-surfactant complex.

8. The pesticidal composition of claim 7, wherein the yeast protein-surfactant complex comprises a heat-shocked yeast Saccharomyces cerevisiae proteins ferment, sodium dioctylsulfosuccinate, propylene glycol, and hexylene glycol.

9. The pesticidal composition of claim 1, further comprising at least one of: insecticide, fungicide and herbicide.

10. The pesticidal composition of claim 1, wherein the AIGA compound comprises sulfoxaflor.

11. The pesticidal composition of claim 10, wherein the soil conditioner comprises a yeast protein-surfactant complex, and wherein the weight ratio of soil conditioner to AIGA compound is at least about 20:1.

12. A method of preparing the pesticidal composition of claim 10, wherein the method comprises mixing at least one soil conditioner with a sulfoxaflor concentrate, wherein the sulfoxaflor concentrate has a sulfoxaflor concentration of 240 g/L or 500 g/kg.

13. A method of controlling soil-dwelling pest, soil-borne pathogen or both, wherein the method comprises applying a pesticidal effective amount of the pesticidal composition of claim 1 to soil.

14. A method of controlling a sap-feeding insect on a top part of a plant, wherein the method comprises applying a pesticidally effective amount of the pesticidal composition of claim 1 to soil around a root system of the plant.

15. The method of claim 14, wherein the sap-feeding insect comprises a green peach aphid (Myzus persicae).

16. A method of controlling a sap-feeding insect on a top part of a plant, wherein the method comprises applying a pesticidally effective amount of the pesticidal composition of claim 10 to soil around a root system of the plant.

17. A method of controlling pests, comprising:
applying a pesticidally effective amount of a pesticidal composition to at least one of: soil, seed of a plant, a portion of a plant, and locus where control of pests is desired,
wherein the pesticidal composition comprises at least one soil conditioner selected from the group consisting of organic soil conditioners, microorganisms, activators, and combinations thereof and an active ingredient group alpha (AIGA) compound,
wherein the weight ratio of soil conditioner to AIGA compound is at least about 20:1.

18. The method of claim 17, wherein the weight ratio of soil conditioner to AIGA compound is between about 100:1 and about 20:1.

19. The method of claim 17, wherein the soil conditioner comprises an organic soil conditioner selected from the group consisting of soil organic matters, humates, animal manures, green manure crops, crop residues, sawdust, waste organic matters, biochar, soya lecithin, yeast protein, yeast protein-surfactant complex, and combinations thereof

20. The method of claim 19, wherein the organic soil conditioner comprises a yeast protein-surfactant complex.

21. The method of claim 17, wherein the AIGA compound comprises sulfoxaflor and the soil conditioner comprises an organic soil conditioner, and wherein the weight ratio of the organic soil conditioner to sulfoxaflor is between about 100:1 and about 20:1.

22. The method of claim 17, further comprising applying another active formulation to at least one of: soil, seed of a plant, a portion of a plant, and locus where control of pests is desired, wherein the another active formulation comprises at least one of insecticide, fungicide and herbicide.

23. The method of claim 22, wherein the pesticidal composition and the another active formulation are applied at the same time.

24. The method of claim 22, wherein the pesticidal composition is applied before or after the another active formulation is applied.

25. The method of claim 17, wherein the pests comprise a sap-feeding insect.
